(19) United States
(12) Patent Application Publication
(10) Pub. No.: US 2004/0243455 A1
(43) Pub. Date: Dec. 2, 2004

(54) Apparatus and method for optimizing a selling environment

(76) Inventor: Martin P. Smith, St. Joseph, MI (US)

Correspondence Address: BARNES & THORNBURG LLP, 600 1st Source Bank Center, 100 North Michigan, South Bend, IN, 46601-1632, US

(21) Appl. No.: 10/833,550

(22) Filed: Apr. 28, 2004

(51) Int. Cl. G06F 17/60

(52) U.S. Cl. 705/7

(57) ABSTRACT

An apparatus and method for optimizing selling environments. A method in a data processing system comprises collecting criteria from at least one buyer and segmenting the criteria into a buyer profile. Next, buyer metrics are retrieved from a memory to analyze the buyer profile. An environment is manipulated in response to the analysis of the buyer profile. An apparatus for enhancing a transaction between a buyer and a seller comprises a transmitter operative with a criteria of the buyer. A receiver associated with the transmitter is configured to communicate the criteria. A processor which is in communication with the receiver has a compilation program which statistically analyzes the criteria. A controller then manipulates an environment in response to a signal from the processor wherein the environment changes to attract at least one of the senses of the buyer.

### BACKGROUND

This disclosure relates to an apparatus and method of measuring the effectiveness of a selling environment to optimize buyer and seller interactions. In particular, the present disclosure measures a diverse set of buyer's criteria to produce an effective driven experience that manipulates the selling environment to enhance the buyer/seller interaction.

In the marketing and merchandising industry, companies allocate resources and capital for retail and tradeshow space by spending for displays, advertising, sales teams and point of purchase materials to sell products. The companies typically focus on the artistic creativity of the retail/booth space in highlighting the products. Currently, though, the retail/booth space is not quantifiably analyzed for the effectiveness of the product sales via the sales environment.

Obtaining buyer comments and reporting the comments to the sellers takes many different forms. Comment cards, which are typically found at consumer service desks or at point-of-sales areas, are common wherein these cards provide a simple check list of topics of interest to the seller, such as customer service or product selection. The cards use several descriptive adjectives or a ranking system in order to rate the seller on a range from low to high, poor to excellent. Comment cards however have drawbacks such as the time and effort spent by the buyer to find and to complete response cards. Additionally, the questionnaire-style formats are relatively inflexible, in that questions are pre-determined to leave little opportunity for addressing the specific concerns of the particular buyer.

Another source of obtaining buyer comments is the customer service desk or customer help line. While the service representatives may listen to the comments by buyers, the representative replies with a limited number of trained responses to the buyer's complaints. As such, the representative may lack the authority to implement a solution to the comment. Thus it may be difficult to identify seller-wide characteristics that need the attention and response of management.

In the merchandising industry, compiling efficient and reliable buyer information is crucial for successfully implementing selling environments such as retail and trade show spaces. As such, merchandising companies need a measurement tool to measure and to rate the effectiveness of the selling environment.

### BRIEF DESCRIPTION OF THE DRAWINGS

The description particularly refers to the accompanying figures in which:

FIG. 1 is a schematic view of a data processing system of an embodiment of the present disclosure;

FIG. 1a is a schematic view of a buyer having criteria measured by the data processing system of FIG. 1;

FIG. 2 is a flowchart illustrating steps of a method of measuring and rating the criteria of FIG. 1a to change a selling environment;

FIG. 3 is a diagram of a selling environment using the data processing system of FIG. 1;

FIG. 4 is a diagram of another selling environment using the data processing system of FIG. 1;

FIG. 5 is a diagram of another selling environment using the data processing system of FIG. 1; and

FIG. 6 is a chart showing criteria measured in the selling environment of FIG. 5.

### DESCRIPTION OF THE DISCLOSURE

The present disclosure relates to an apparatus and method which measures characteristics of a customer or buyer who enters a selling environmental such as a retail store, a tradeshow or a trade booth. The present disclosure analyzes criteria of the buyer to change the selling environment in real time to enhance interactions between the buyer and seller. The changes to the selling environment result from the analysis of the buyer's criteria and buyer's interaction with the selling environment.

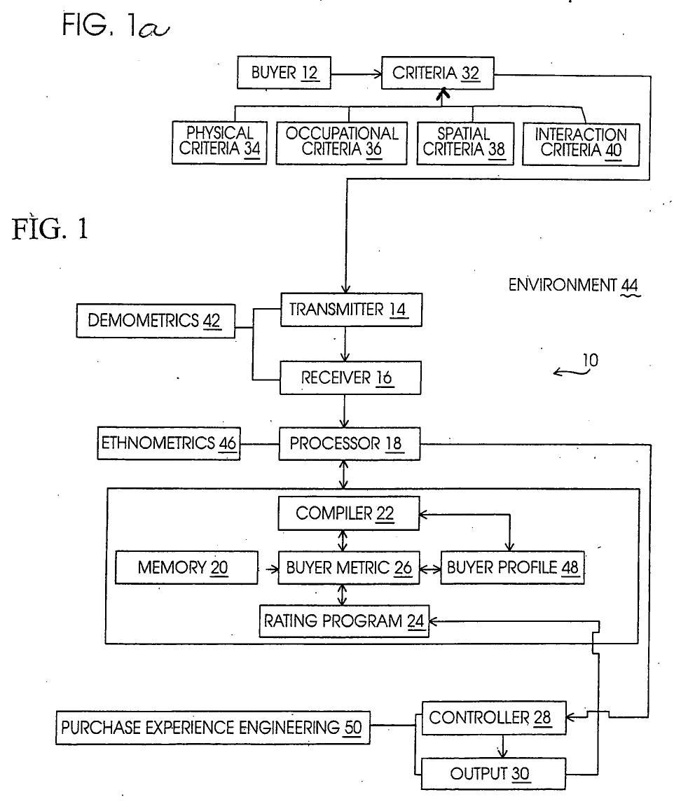

FIG. 1 illustrates a data processing system 10 of the present disclosure in a schematic view, wherein the data processing system 10 measures and analyzes buyer information as will be discussed. The data processing system 10 comprises a transmitter 14 and a receiver 16 wherein the transmitter 14 sends the buyer information to the receiver 16.

The data processing system 10 further includes a processor 18 which communicates with the receiver 16 in order to rate the buyer information. The processor 18, in turn, includes a memory 20, a compiler 22 and a rating program 24. The memory 20 further includes a buyer metric database 26 wherein the buyer metric database 26 supplies stored information to compare with the buyer information.

The data processing system 10 further includes a controller 28 and an output 30. The controller 28 communicates with the processor 18 wherein in response from the processor 18 the controller 28 activates the output 30. As such, the controller 28 activates the output 30 based on instructions from the processor 18, as will be discussed.

Turning to FIG. 1a, a buyer 12 is any person interested in viewing and/or purchasing a product within a selling environment 44 such as a retail store, trade booth or tradeshow. Each buyer 12 has a criteria 32 which assists in identifying the buyer 12. For example, the buyer 12 has physical characteristics such as gender, age, and ethnic background. Additionally, the buyer 12 has occupational characteristics such as job title, seniority and experience. Furthermore, in a purchasing situation, the buyer 12 has spatial characteristics such as a location near a prospective product. The buyer 12 also has interaction characteristics such as touching the prospective product or interacting with sales personnel. Accordingly, the criteria 32 of the buyer 12 includes information such as but not limited to: at least one physical criteria 34; at least one occupational criteria 36, at least one spatial criteria 38 and at least one interaction criteria 40.

Returning to FIG. 1, the collection of the criteria 32 refers to a process called demometrics 42. Demometrics 42 relates to a process which focuses on measuring information typically pertaining to populations of people such as buyers 12. In particular, demometrics 42 relates to a process of measuring the criteria 32 of the buyer 12 as will be discussed. Tables 1-4 list examples of measured criteria 32. In particular, Table 1 refers to examples of physical criteria 34, Table 2 refers to examples of occupational criteria 36, Table 3 refers to examples of spatial criteria 38, while Table 4 refers to examples of interactive criteria 34.

TABLE 1
Physical criteria 34

What is the age of the buyer?
What is the gender of the buyer?
What is the ethnic background of the buyer?
What are the physical dimensions of the buyer?
How many buyers attend the overall sales event?

TABLE 2
Occupational criteria 36

What is the title of the buyer?
What is the experience of the buyer?
What is the seniority of the buyer?
What company is represented by the buyer?
What is the number of buyers with a specific retail/booth product in mind
before coming to the event?
What buyers are looking for specific type of product information?
What is the number of times promos/offers were taken advantage of by the
buyers?
What is the number of buyers who understand the message communicated
in the display/exhibit/promotions?
What is the number of buyers who are loyal to the product/service/brand?
What is the number of repeat buying behaviors?
What is the number of buyers who gain a specific type of information to
assist in the purchase decision?
What is the number of buyers who obtain a specific level of event
coverage?
What is the number of buyers with a specific brand in mind?
What is the number of buyers with material/information in hand?

TABLE 3
Spatial criteria 38

What direction do buyers go?
How many buyers go in a particular direction?
How many buyers visit a retail space/booth?
Do buyers enter and leave together?
What is the length of time spent by buyers around a display/exhibit?
What is the number of buyers in line?
What is the average traffic flow into the retail space/booth?
What is the number of buyers that travel in a specific traffic pattern?
What is the average time spent with the sales associate?
What is the average time spent by buyers in the event?
What is the percent of time each section is visited by buyers?
What is the average number of products visited and purchased within the
retail space/booth by the buyers?
How many buyers visit the event by area and/or by time of day?

TABLE 4
Interaction criteria 40

What is the first product buyers touch or look at?
What is the number of touches on the display/product?
What is percentage of buyers who stop and actively visit the
display/product?
What is the number of buyers who use a display/product in a specific
fashion?
What is the number of times the display/exhibit assisted a buyer's
decision?
What is the number of buyers who gain information from the
display/product?
What is the number of buyers who had reactions to the display/product?
What is the number of buyers who liked and disliked specific items on the
display/product?
What is the number of buyers who were effected by the use of point of
purchase materials?
What is the number of buyers who are influenced to purchase by the
display/exhibit/promotion?
What is the number of buyers who visit a specific product first?
What is the number of engagements by the sales force with buyers?
What is the number of buyers who gain a specific depth of information
from a display/product?
What is the number of buyers who exhibit specific product examination
procedure (looking, touching, tasting)?
What is the number of exhibitors who change their space/booth in reaction
to display/product?
What is the number of buyers who leave contact information?
What is the average monetary amount spent by buyers?
How many buyers interact with a salesperson?

Returning to FIGS. 1 and 1a, the buyer 12 communicates the criteria 32 to the transmitter 14. In an embodiment, the buyer 12 may be associated with a transmitter 14 such as a radio frequency identification tag which is configured to store and to transmit the criteria 32. In this embodiment, the transmitter 14 may be downloaded with the criteria 32 of the buyer 12. In the selling environment 44 such as a tradeshow, each buyer 12 may submit criteria 32 to the tradeshow planner prior to attending the tradeshow. The tradeshow planner, in turn, compiles and downloads the criteria 32 into the transmitter 14. Then, the tradeshow planner assigns the particular transmitter 14 to the appropriate buyer 12 who wears the transmitter 14 while attending the selling environment 44. The buyer 12 activates the transmitter 14 to send the criteria 32 throughout the selling environment 44 as the buyer 12 walks within the selling environment 44 as will be discussed.

In submitting the criteria 32 to the tradeshow planner, the buyer 12 may disclose a variety of information to store in the transmitter 14. For example, the transmitter 14 may store the physical criteria 34 of the buyer 12 with information such as name, age, gender, and ethnic background of the buyer 12. The transmitter 14 may also store the occupational criteria 36 of the buyer 12 such as the company represented by the buyer 12, the title of the buyer 12, and the seniority/experience of the buyer 12. For example, the transmitter 14 may store information under the occupational criteria 36 to highlight the title of the buyer 12, such as corporate executive or purchasing manager. The transmitter 14 sends the physical criteria 34 and the occupational criteria 36 as the buyer 12 moves within the selling environment 44 to expose the information.

The transmitter 14 may also be configured to send location signals as the buyer 12 moves within the selling environment 44. Thus, the transmitter 14 sends the spatial criteria 38 to highlight the position of the buyer 12 within the selling environment 44. For example, the transmitter 14 may transmit the current physical location of the buyer 12 within the selling environment 44 and the past locations of the buyer 12 within the selling environment 44. Thus the transmitter 14 sends signals of spatial criteria 38 to trace the flow of the buyer 12 through the selling environment 44.

The transmitter 14 is also configured to send interaction signals as the buyer 12 moves within the selling environment 44. Thus, the transmitter 14 sends interaction criteria 40 to highlight the interaction of the buyer 12 within the selling environment 44. For example, the transmitter 14 may communicate with a product sensor located on a product that the buyer 12 is testing. The product sensor may communicate an activation signal to the transmitter 14 which sends interaction criteria 40 to highlight the activity of the buyer 12 within the selling environment 44.

Regardless of the type of criteria 32 communicated by the buyer 12, the transmitter 14 sends the criteria 32 to the receiver 16. The receiver 16, in turn, relays the criteria 32 to the processor 18, as will be discussed. In an embodiment, the transmitter 14 comprises an “active” mode which continually sends the criteria 32 to be picked up by the receiver 16 while the buyer 12 attends the selling environment 44. In this embodiment, the receiver 16 may comprise a plurality of receivers 16 positioned throughout the selling environment 44. As such, ongoing, real time transfer of the criteria 32 occurs between the transmitter 14 and the receiver 16.

In another embodiment, the buyer may be associated with transmitter 14 such as the radio frequency tag in the selling environment 44 such as a trade booth. In this embodiment, the trade booth comprises an individual selling space for a particular company attending a tradeshow. In this embodiment, the transmitter 14 may be downloaded with the criteria 32 of the buyer 12 in the manner previously described.

In submitting the criteria 32 to the tradeshow planner, the buyer 12 may disclose a variety of information to store in the transmitter 14 as previously described. In this embodiment, the transmitter 14 may comprise a “passive” mode which does not continually send the criteria 32 to the receiver 16. Instead, the selling environment 44 activates the transmitter 14 to send the criteria 32. As such, the receiver 16 may be positioned at a fixed location within the selling environment 44.

In this embodiment, the selling environment 44 may include a sensor which activates the transmitter 14 when the buyer 12 enters the selling environment 44. For example, the sensor located on a doorway of a trade booth (selling environment 44) activates the transmitter 14 when the buyer 12 enters the trade booth. Upon activation, the transmitter 14 sends the criteria 32 to the receiver 16 positioned within the trade booth. For example, the transmitter 14 may store the physical criteria 32 such as name, age, gender and ethnic background of the buyer 12. The transmitter 14 may also store the occupational criteria 36 of the buyer 12 such as the company represented by the buyer 12, the title of the buyer 12 and the seniority/experience of the buyer 12.

In this “passive” mode, the transmitter 14 is also configured to send location signals such as the spatial criteria 38 as the buyer 12 walks within the trade booth. Thus the transmitter 14 sends spatial criteria 38 to highlight the position of the buyer 12 within the selling environment 44. For example, the transmitter 14 may transmit the current physical location of the buyer 12 within the trade booth and the past locations of the buyer 12 within the trade booth. Accordingly, the transmitter 14 sends signals to trace the flow of the buyer 12 through the trade booth. The transmitter 14 is also configured to send interaction signals as the buyer 12 attends the trade booth by sending interaction criteria 40 to highlight the interactions of the buyer 12 within the selling environment 44. For example, the transmitter may communicate with a product sensor located on the product that the buyer 12 is testing. The product sensor may communicate an activation signal to the transmitter 14 which sends the interaction criteria 40 to the receiver 16 to record the activity of the buyer 12 within the trade booth. It should be known that the “active/passive” mode of the transmitter 14 is not limited to any particular type of selling environment 44.

In another embodiment, the buyer 12 may also act as the transmitter 14. In this embodiment, the buyer 12 externally displays the criteria 32 by the physical make up of the buyer 12 as the buyer 12 moves through the selling environment 44 such as a retail space. For example, the buyer 12 transmits physical criteria 34 such as age, gender, and ethnic background. Additionally, the buyer 12 may transmit occupational criteria 36, such as a name tag listing the company and position of the buyer 12.

In this embodiment, the receiver 16 may be a video recorder, which records the buyer 12 to relay the criteria 32 that the buyer 12 is externally presenting while positioned within the selling environment 44. For example, the receiver 16 records the buyer 12 as the buyer 12 enters the selling environment 44 such as the retail space. The receiver 16 then relays the criteria 32 presented by the buyer 12 to the processor 18 as will be discussed. As the transmitter 14, the buyer 12 displays the physical criteria 34 and occupational criteria 36 while sending location signals as the buyer 12 moves within the retail space. Thus the transmitter 14/buyer 12 also sends spatial criteria 38 to highlight the position of the buyer 12 within the retail space. For example, the transmitter 14/buyer 12 may transmit the current physical location of the buyer 12 within the retail space and the past locations of the buyer 12 within the retail space. Thus the receiver 16 records the spatial criteria 38 to trace the flow of the buyer 12 through the retail space. The receiver 16 is also configured to record interaction signals as the buyer 12 moves within the retail space. Thus, the receiver 16 records interaction criteria 40 to highlight the interactions of the buyer 12 within the retail space. For example, the receiver 16 may record testing by the buyer 12 on a prospective product.

Regardless of the configuration of the transmitter 14 and the receiver 16, the demometrics process 42 relays the criteria 32 from the buyer 12 to the processor 18 via the transmitter 14 and receiver 16. Thus, in the demometrics process 42, the criteria 32 is measured and transmitted by the transmitter 14 to the receiver 16 which communicates the criteria 32 to the processor 18 such as a central processing unit.

The compilation of the criteria 32 by the processor 18 refers to a process called ethnometrics 46 as illustrated in FIG. 1. Ethnometrics 46 relates to the study and application of statistical methods to the analysis of segmented demometric information 42. In other words, ethnometrics 46 is a process of dividing criteria 32 which was measured by the demometric process 42 into defined sampling segments driven by a statistical analysis.

Under the ethnometrics process 46, the processor 18 compiles and analyzes the criteria 32 such as the physical criteria 34; the occupational criteria 36; the spatial criteria 38 and interaction criteria 40 with respect to the buying behavior of the buyer 12. Table 5 lists examples of such buying behavior under the ethnometrics process 46.

TABLE 5
Ethnometrics Process 46

| | | |
|---|---|---|
| How long do buyers stay? | What is the percentage of buyers | What is the number of buyers |
| | by category who visit multiple | by category? |
| | products? | |
| Do the buyers stand in line? | What is the time spent in one | What is the number of sales |
| | booth versus another? | person interactions? |
| How long do the buyers stand in | What is the buyer index by | What is the number of printed |
| line? | category of total buyers versus | off materials? |
| | buyers of display/exhibit? | |
| What is the time spent at the | What is the percentage of buyers | What is the number of touches |
| display/exhibit by category? | who notice and enter by | to a specific product? |
| | category? | |
| What are the products visited by | What is the number of | What is the number of buyers |
| category? | interactions versus number of | by point of entry? |
| | conversions by category? | |
| What is the buyer conversion rate, | What is the type of uses by | What is the time spent with |
| i.e. percent of buyers who purchase | category? | sales person? |
| any of the display/exhibit products. | | |
| What is the number of buyers who | What is the number of buyers by | What is the time spent by |
| use a display/exhibit in a specific | category who have | category? |
| fashion by category? | preference/consideration/satisfaction | |
| | change in purchase | |
| | experience? | |
| What is the number of times | Where is the first location visited | What is the time spent in |
| displays/exhibits helped close a sale | by category? | booth? |
| by category? | | |
| What is the number of uses by | What is the number of sales | What is the number of |
| category? | force personnel who exhibit a | interactions with sales staff? |
| | specific attitude toward | |
| | product/brand? | |
| What is the number of buyers by | What is the number of buyers by | What is the interaction with |
| category who had reactions to the | category assisted in an area or | product, attractions, demos, |
| display/exhibit? | region? | presentation? |
| What is the number of buyers by | What is the percentage of time | What is the first item |
| category who were effected by the | each section is visited by a | touched/interaction/draw? |
| use of the point of purchase | category? | |
| material? | | |
| What is the number of buyers by | What is the average time spent | What is the number of buyers |
| category who travel in a specific | by buyer category? | by ethnometric category who |
| traffic pattern? | | exhibits specific product |
| | | examination procedure? |
| What is the number of buyers by | What is the number of buyer by | What is the number of buyers |
| category who enter the | category who like and dislike | by category who were |
| show/exhibit/display? | specific items on a | influenced to purchase by the |
| | display/exhibit? | displays/exhibit/promotion? |
| What is the number of repeat | What is the number of buyers by | What is the product conversion |
| consumer by category buying | category who gain a specific | rate: percentage of time |
| behaviors and repeat purchase | type of information to assist in | products are purchased after |
| behaviors? | the purchase decision? | being visited by category? |
| What is the number of buyers by | What is the percentage by | |
| category who are influenced by the | category who purchase? | |
| promo/display/exhibit? | | |

The processor 18 sends the criteria 32 to compiler 22 which segments the criteria 32 into a buyer profile 48. The buyer profile 48 is created by segmenting the different criteria 32 into a database. The compiler 22 then retrieves buyer metrics 26 from the memory 20 wherein the buyer metrics 26 is another database of prior buying behavior for past criteria 32. The compiler 22 compares the current buyer profile 48 to the buyer metrics 26. The compiler 22 analyzes the buyer profile 48 based on the buyer metrics 26. Based on the comparison of the buyer profile 48 with the buyer metrics 26, the compiler 22 communicates the analyzed buyer profile 48 to a controller 28 which is in communication with the selling environment 44.

The segmented criteria 32 is defined and driven by different categories, i.e. solo versus group divisions, gender, occupational, ethnic, and cultural divisions or spatial divisions. Under the ethnometrics process 46, category segmentations are combined with financial behaviors and economics such as: spending behavior, return behavior, margin and/or sales or revenue generation information. Furthermore, directional flow or other dynamic fluid parameters are incorporated as a point of segmentation. These segmented response variables are statically compared and analyzed by a mathematical indexing model such as:

Y=Ay₁^{a}+By₂^{b}+Cy₃^{c}+Dy₁₂^{d}+Ey₁₃^{e}+Fy₂₃^{f}+Gy₁₂₃^{g} (1)

wherein dependent variables are further broken down into sub-equations of the form;

y₁=Ax₁^{a}+Bx₂^{b}+Cx₃^{c}+Dx₁₂^{d}+Ex₁₃^{e}+Fx₂₃^{f}+Gx₁₂₃^{g} (2).

The indexing model compares and analyzes the response variable (Y), the sub-factors or dependent variables (y) and factors or independent variables (x) that determine the magnitude of the response. In the case of purchase experience conversion rate, the Y variable is the volume of sales which will take place as a result of a defined list of factors generating a Y=f(x) equation.

In an example, the receiver 16 may relay physical criteria 34 such as the gender (male) of the buyer 12; the occupational criteria 36 such as the company title (purchasing manager) of the buyer 12; the spatial criteria 38 such as current location (near a prospective product) of the buyer 12 within the selling environment 44 and the interaction criteria 40 such as the conduct of the buyer 12 (reading product literature). The compiler 22 then segments the criteria 32 into the buyer profile 48. Accordingly, the compiler 22 segments the gender, company title, location and action of the buyer 12 to compile the buyer profile 48. Next, the compiler 22 compares the buyer profile 48 to the buyer metrics 26 wherein the buyer metrics 26 includes information such as purchasing behavior of male purchasing managers who have entered the selling environment 44 while reading product literature. The processor 18 will then communicate the analysis of the buyer profile 48 to the controller 28 for the appropriate response, as will be discussed.

Referring to FIG. 1, upon receiving the analyzed buyer profile 48 from the processor 18, the controller 28 generates an output 30 wherein the output 30 changes the selling environment 44. The manipulation of the selling environment 44 by the processor 18 refers to a purchase experience engineering process 50. Under purchase experience engineering process 50, the selling environment 44 is specifically manipulated using outputs 30 commanded by the controller 28 in order to obtain the maximum purchasing behavior of the buyer 12 with a minimum of resources and capital. The output 30 comprises a variety of functions to attract the buyer 12 based on the analyzed buyer profile 48. Table 6 list examples of outputs 30.

TABLE 6
Purchase Experience Engineering Process 50

Activate sensory device to attract at
least one of the senses of the buyer.
Present new product releases.
Present educational seminars.
Present celebrities.
Present CEO presentations.
Present food.
Present entertainment.
Present models.
Activate product.
Alert sales team.

The controller 28 generates the output 30 in order to attract the buyer 12 with respect to the selling environment 44. For example, the output 30 may comprise activating a product of interest to the buyer 12. Thus, when the buyer 12 enters a selling environment 44 the controller 28 in response from the processor 18 generates the output 30. The buyer 12, in response, is attracted to the output 30 advancing the purchasing behavior of the buyer 12.

The output 30 may comprise activating sensory devices which attract at least one of the senses of the buyer 12. Accordingly, the output 30 may include auditory, visual, touch, smell or taste functions. For example, the output 30 may comprise activating music and activating lights to attract the buyer 12 to the product. Additionally the output 30 may comprise generating a scent in order to attract the buyer 12 to the product. Further, the output 30 may comprise activating the product such that the buyer 12 touches the product. Additionally the output 30 may comprise presenting food to attract the buyer 12 to the product. The output 30 may also comprise alerting a sales team member to interact with the buyer 12 as the buyer 12 enters the selling environment 44. The output 30 may also comprise activating an educational seminar or presenting a celebrity or CEO to the buyer 12 as the buyer enters the selling environment 44. Thus the controller 28 activates the output 30 in order to manipulate the selling environment 44 in response to the analysis of the criteria 32 and analyzed buyer profile 48. Thus, the buyer 12 enters selling environment 44 and the selling environment 44 changes based on the specific buyer profile 48 of the buyer 12 as recorded by the transmitter 14/receiver 16 and analyzed by the processor 18.

The present disclosure attracts the buyer 12 with the output 30 which can not only optimally point the buyer 12 to complimentary products and services but can also provide the buyer 12 with an individually tailored purchase experience based on the buyer profile 48. Accordingly, the selling environment 44 becomes dynamic by activating and deactivating products and displays based on the buyer profile 48 which relates the preferences of a certain brand, color, sound, smell or taste. Thus, the present disclosure harnesses the power of the individual sensory preference of the buyer 12 and manipulates the selling environment 44 to match the buying pattern of the buyer 12. Accordingly, the buyer 12 is guided to specific products based on the purchase history and/or aspiration buying desires of the buyer 12. The selling environment 44 dynamically changes in real time to match the actual buying interest and activity level of the individual buyer 12. For example, the present disclosure might deliver a specific output 30 to the buyer 12 such as a corporate executive and a completely different output 30 to the buyer 12 such as a purchaser.

After the output 30 attracts the buyer 12, the processor 18 records the buying behavior of buyer 12. The processor 18 relays the buying behavior to the rating program 24 which then rates the conversion rate of the selling environment 44. Thus, the data processing system 10 of the present disclosure rates the effectiveness of the selling environment 44 to enhance future buyer/seller interactions.

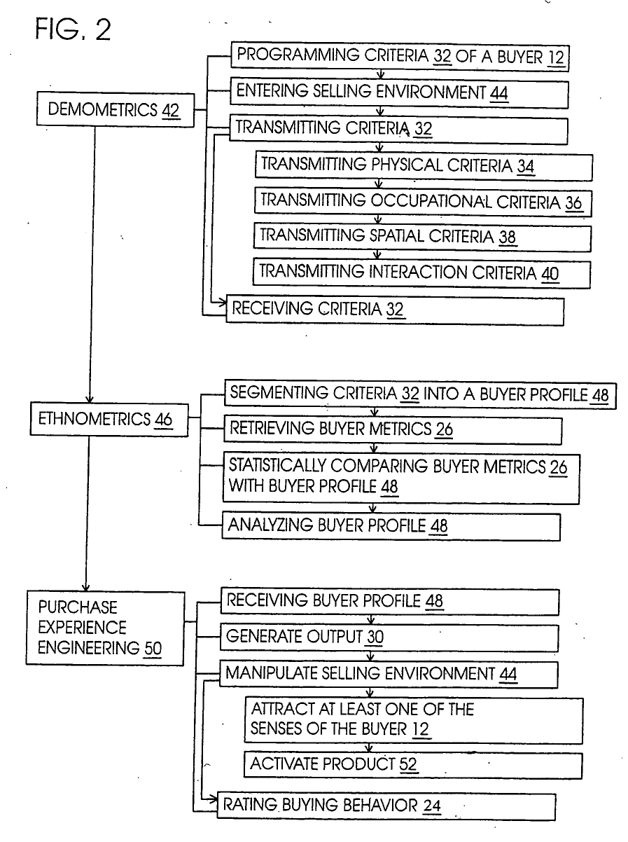

Turning to FIG. 2, the flowchart illustrates the steps of the present disclosure which measures the criteria 32 and changes the selling environment 44 based on the criteria 32 to analyze and enhance buyer and seller interactions. During use, the present disclosure first performs the demometric process 42 by measuring the criteria 32 of the buyer 12 via the communication among the transmitter 14, receiver 16 and processor 18. Next, the ethnometrics process 46 analyzes the criteria 32 and compiles the buyer profile 48. Then, the purchase experience engineering process 50 generates the output 30 based on the buyer profile 48. Based on the interaction of the buyer 12 and the output 30, the processor 18 then records the interaction of the buyer 12 within the selling environment 44. The rating program 24 then rates the buying behavior of the buyer 12 with respect to the selling environment 44.

Still referring to FIG. 2, the buyer 12 inputs the criteria 32 into the transmitter 14. When the buyer 12 enters the selling environment 44, the transmitter 14 emits the criteria 32 within the selling environment 44. The criteria 32 may include the physical criteria 34, the occupational criteria 36, the spatial criteria 38 or the interaction criteria 40. The receiver 16 then receives the criteria 32 for further processing by the demometric process 42.

Next under the ethnometric process 46, the processor 18 communicates the criteria 32 from the receiver 16 to the compiler 22 which segments the criteria 32 into a buyer profile 48. The compiler 22 retrieves previously stored buyer metrics 26 from the memory 20 and statistically compares the buyer metric 26 to the buyer profile 48. The compiler 22 then statistically analyses the buyer profile 48 and communicates the analyzed buyer profile 48 to the controller 28.

The controller 28, in response to commands from the processor 18, generates the output 30 to attract the buyer 12. Under the purchase experience engineering process 50, the controller 28 manipulates the selling environment 44 based on the analyzed buyer profile 48. In manipulating the selling environment 44, the output 30 from the controller 28 attracts at least one of the senses of the buyer 12. The output 30 may also comprise activating and/or deactivating a product 52. The processor 18 rates the buying behavior of the buyer 12 with respect to the output 30 and sends the information to the rating program 24. The rating program 24 then converts the buying experience and stores the buying experience as a new buyer metric 26 in the memory 20.

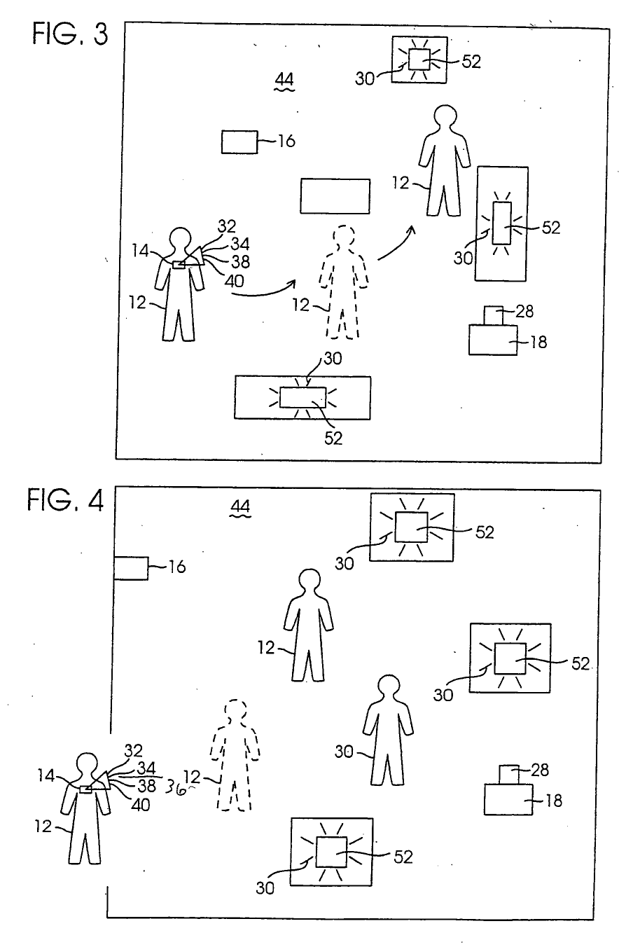

Turning to FIG. 3, the selling environment 44 is shown in an embodiment as a retail space. The selling environment 44 may comprise any retail space positioned within a variety of stores such as a department store, office supply store or electronics store. As illustrated, the selling environment 44 positions at least one receiver 16 within the retail space while positioning retail display cases having a variety of products 52 positioned thereon. The selling environment 44 further positions the processor 18 and the controller 28 within the retail space. In this embodiment, the buyer 12 acts as the transmitter 14 by displaying criteria 32 such as physical criteria 34, spatial criteria 38 and interaction criteria 40.

As illustrated, the buyer 12/transmitter 14 enters the selling environment 44. Under the demometrics process 42, the buyer 12 externally transmits criteria 32 such as physical criteria 34 including age and gender. The buyer 12 further transmits spatial criteria 38 such as a position within the selling environment 44 such as the entrance. Further, the buyer 12 transmit interaction criteria 40 such as approaching and touching one of the products 52. The receiver 16, such as a video recorder, records the criteria 32 being transmitted by the buyer 12. The receiver 16 then relays the criteria 32 to the processor 18.

Under the ethnometrics process 46, the processor 18 segments the criteria 32 into the buyer profile 48 (FIGS. 1 and 2). For example, the processor 18 may segment the criteria 32 as a middle-aged male entering the selling environment 44 to approach one of the products 52. In an embodiment, personnel of the retail space may view the recording of the receiver 16 and use the processor 18 to segment the criteria 32 into the buyer profile 48. Next the processor 18 retrieves buyer metrics 26 (FIGS. 1 and 2) from the memory 20 while the buyer 12 remains in the selling environment 44. The compiler 22 (FIGS. 1 and 2) then statistically compares the buyer metrics 26 with the buyer profile 48 in order to analyze the buyer profile 48.

Next under the purchase experience engineering process 50, the analyzed buyer profile 48 is sent to the controller 28. Based on the analyzed profile 48, the processor 18 commands the controller 28 to generate the output 30. The output 30 activates to manipulate the selling environment 44 to attract the buyer 12 to one of the products 52 based on the buyer profile 48. As such, the output 30 manipulates the selling environment 44 by attracting at least one of the senses of the buyer 12. For example, the output 30 may turn on lights near one of the products 52 which corresponds with the buyer profile 48. Additionally, the output 30 may activate music to attract the buyer 12 to one of the products 52 based on the buyer profile 48. Additionally, the output 30 may alert a sales team member to interact with the buyer 12 to discuss one of the products 52 based on the buyer profile 48. Still further the output 30 may activate one of the products 52 in order to attract the buyer 12 based on the buyer profile 48. Then the processor 18 records the buying behavior of the buyer 12 with respect to the output 30 and sends the buyer behavior information to the rating program 24. The rating program 24 then converts the buying experience to measure the rate of return of the selling environment 44.

As an example of the illustrated embodiment of FIG. 3, the processor 18 segments the criteria 32 into the buyer profile 48 such that the criteria 32 indicates: a middle-aged male in a retail space such as a lawn and garden center who initially approaches one of the products 52 such as a push lawn mower upon entering the selling environment 44. The compiler 22 retrieves buyer metrics 26 from the memory 20 for comparison to create the buyer profile 48 such as a buyer 12 seeking a high end lawn mower based on the age, gender and interaction of the buyer 12. Accordingly, the output 30 may activate lights near the first lawn mower to attract the buyer to this product 52. Next the output 30 may activate an audio video of another product 52 such as a self propelled lawn mower to attract the buyer 12 deeper into the selling environment 44. Then the processor 18 may direct the controller 28 to command the output 30 to activate another product 52 such as a riding lawn mower. This additional product 52 may be positioned deeper within selling environment 44 to attract the buyer 12. As such, the selling environment 44 changes based on the buyer profile 48 to attract the buyer 12 to one of the preferred products 52. Next, the buyer 12 interacts with the preferred product 52 such as touching the preferred product 52 or interacting with a sales team member to discuss the preferred product 52.

The receiver 16, meanwhile, records the spatial criteria 38 as the buyer 12 moves within the selling environment 44 and records the interaction criteria 40 as the buyer interacts within the selling environment 44. The receiver 16 and processor 18 then communicate in order to relay the buying behavior to the rating program 24.

Turning to FIG. 4, the selling environment 44 is shown in an embodiment such as a trade booth. As illustrated, the selling environment 44 positions at least one receiver 16 within the trade booth while positioning point of purchase displays having a variety of products 52 positioned thereon. The selling environment 44 further positions the processor 18, the controller 28 and output 30 within the trade booth. The buyer 12 wears the transmitter 14 having criteria 32 downloaded as previously discussed.

As illustrated, the buyer 12 enters a selling environment 44 wearing the transmitter 14 which may activate in the “passive” mode. The receiver 16 may activate the transmitter 14 when the buyer 12 enters the selling environment 44. Upon activation, the transmitter 14 sends the criteria 32 to the receiver 16. As such, the transmitter 14 sends criteria 32 such as physical criteria 34 including name, age and gender of the buyer 12. Further, the transmitter 14 transmits occupational criteria 36 such as the title of the buyer 12. The receiver 16 then relays the criteria 32 to the processor 18. Additionally, the receiver 16 may relay spatial criteria 38 such as the movement of the buyer 12 within the trade booth.

After the receiver 16 activates the transmitter 14 as the buyer 12 enters the trade booth, the processor 18 segments the criteria 32 sent by the transmitter 14 into the buyer profile 48 (FIGS. 1 and 2) by the ethnometrics process 46. For example, the processor 18 may segment the criteria 32 as a purchasing manager of a certain company who enters the selling environment 44. The processor 18 retrieves buyer metrics 26 (FIGS. 1 and 2) from the memory 20 (FIGS. 1 and 2) while the buyer 12 moves within the trade booth. The compiler 22 (FIGS. 1 and 2) then compares the buyer metrics 26 with the buyer profile 48 in order to statistically analyze the buyer profile 48.

Next, the analyzed buyer profile 48 is sent to the controller 28. Based on the analyzed profile 48, the processor commands the controller 28 to generate the output 30. The output 30 activates to manipulate the selling environment 44 to attract the buyer 12 to one of the products 52 based on the buyer profile 48. As such, the output 30 manipulates the selling environment 44 by attracting at least one of the senses of the buyer 12. For example, the output may activate product 52 which relates to a new line of brands being offered by the company. The output 30 activates this particular new line product 52 based on the buyer profile 48 of the buyer 12 having occupational criteria 36 listing the buyer 12 as a marketing manager. As such, the output 30 directs the buyer 12 to the particular product 52 to further enhance the buyer behavior.

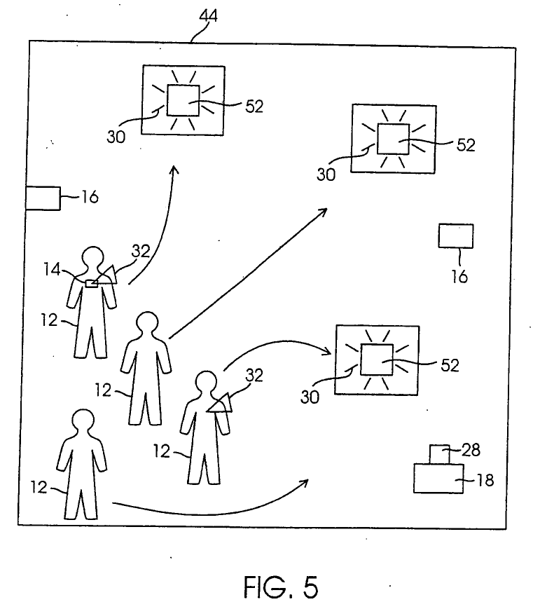

Turing to FIG. 5, selling environment 44 is shown as an embodiment as a trade show. As illustrated, selling environment 44 positions at least one receiver 16 within the tradeshow while positioning trade booths having a variety of products 52 positioned therein. The selling environment 44 further positions the processor 18, the controller 28 and the output 30 within the tradeshow space. In this embodiment, the buyer 12 may use the transmitter 14 which works in a “active” mode. As such, the buyer 12 uses the transmitter 14 having criteria 32 downloaded as previously discussed.

As illustrated, the buyer(s) 12 enters the selling environment 44 wherein the transmitter 14 transmits criteria 32 to the at least one receiver 16 in an ongoing, real time transfer manner. Under the demometric process 42, the transmitter 14 sends the criteria 32 on a continuing basis throughout the selling environment 44. The criteria 32 may comprise spatial criteria 38 which lists the different positions of the buyer(s) 12 within the selling environment 44. The at least one receiver 16 positioned within the selling environment 44 then relays the criteria 32 to the processor 18.

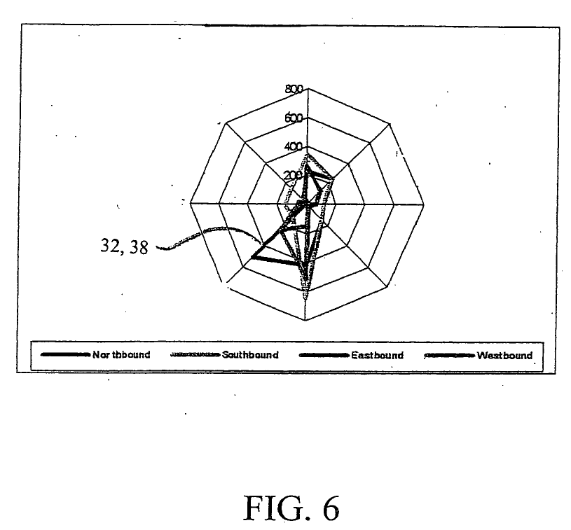

Under the ethnometric process 46, the processor segments the criteria 32 into the buyer profile 48 (FIGS. 1 and 2). For example, the processor 18 may compile the buyer profile 48 as showing the traffic flow pattern of the buyers 12 throughout the selling environment 44. The buyer profile 48 may indicate a congestion of buyers 12 based on the spatial criteria 38 emitted by each transmitter 14. Turning to FIG. 6, the buyer profile 48 is shown graphically in a chart to highlight the spatial criteria 38 of the buyers 12. As shown, the spatial criteria 38 of the buyer(s) 12 indicates a congestion within the selling environment 44.

Returning to FIG. 5, the processor 18 retrieves buyer metrics 26 from the memory 20 while the buyer(s) 12 remains in the selling environment 44. The compiler 22 then compares the buyer metrics 26 with the buyer profile 48 in order to analyze the buyer profile 48. For example, the buyer metrics 26 may include the physical layout of the tradeshow. The compiler 22 then would analyze the buyer profile 48 showing a congestion of buyer(s) 12 with the tradeshow layout incorporated into the buyer metrics 26.

Under the purchase experience engineering process 50, the analyzed buyer profile 48 is sent to the controller 28. Based on the analyzed profile 48 the processor 18 commands the controller 28 to generate the output 30. The output 30 activates to manipulate the selling environment 44 to attract the buyers 12 in order to relieve the congestion based on the buyer profile 48. As such, the output 30 may alert a tradeshow personnel to direct buyers 12 into another area of the selling environment 44 to relieve the congestion. Additionally, the output 30 may visually and audibly signal a demonstration in order to direct some of the buyers 12 out of the congested area. Further, the output 30 may open a food kiosk to direct some the buyers 12 out of the congested area.

The present disclosure measures the effectiveness of a selling environment and creates a fulfilling and memorable interaction between buyer and seller while optimizing the return on investment. Additionally, the present disclosure measures a diverse set of buyer criteria which provides insight into the effectiveness of space layout and design, advertising and point of purchase materials, as well as the effectiveness of the sales force in creating an environment that promotes interaction from contact and awareness to final purchase. Thus, the present disclosure reduces the uncertainty most marketers and merchandisers face and leads to maximum rate on marketing investment. The present disclosure relates to not only the main effect, i.e. the amount of purchase driven by individual buyers of a specific output such as an advertising message, point of purchase display or sales force, but also the interactive effects, i.e. the amount of purchase driven by the combined outputs. Thus, understanding the main and interactive effects leads to easier decisions for spending and resource allocations in order to maximize the return on investments.

While the concepts of the present disclosure have been illustrated and described in detail in the drawings and foregoing description, such an illustration and description is to be considered as exemplary and not restrictive in character, it being understood that only the illustrative embodiments have been shown and described and that all changes and modifications that come within the spirit of the disclosure are desired to be protected by the following claims.

I claim:

1. A method in a data processing system, comprising:
collecting criteria from at least one buyer;
segmenting the criteria into a buyer profile;
retrieving buyer metrics from a memory to analyze the buyer profile; and
manipulating an environment in response to the analysis of the buyer profile.

2. The method in a data processing system according to claim 1, wherein collecting the criteria comprises collecting at least one physical criteria of the at least one buyer.

3. The method in a data processing system according to claim 1, wherein collecting the criteria comprises collecting at least one occupational criteria of the at least one buyer.

4. The method in a data processing system according to claim 1, wherein collecting the criteria comprises collecting at least one spatial criteria of the at least one buyer.

5. The method in a data processing system according to claim 1, wherein collecting the criteria comprises collecting at least one interaction criteria of the at least one buyer.

6. The method in a data processing system according to claim 1, further comprising transmitting the criteria from the at least one buyer.

7. The method in a data processing system according to claim 6, further comprising receiving the criteria.

8. The method in a data processing system according to claim 7, wherein transmitting and receiving the criteria comprises processing radio frequency identification.

9. The method in a data processing system according to claim 7, wherein transmitting and receiving the criteria comprises recording video of the actions of at least one buyer.

10. The method in a data processing system according to claim 1, further comprising comparing the buyer metric with the buyer profile.

11. The method in a data processing system according to claim 1, further comprising statistically analyzing the buyer profile.

12. The method in a data processing system according to claim 1, wherein manipulating the environment comprises attracting at least one of the senses of the at least one buyer.

13. The method in a data processing system according to claim 1, wherein manipulating the environment comprises activating at least one product within the environment.

14. The method in a data processing system according to claim 1, wherein the environment is a tradeshow.

15. The method in a data processing system according to claim 1, wherein the environment is a retail space.

16. The method in a data processing system according to claim 1, wherein the environment is a trade booth.

17. A method in a data processing system of enhancing a buyer seller interaction by manipulating an environment, comprising:
transmitting a criteria from at least one buyer;
receiving the criteria to segment the criteria into a buyer profile;
retrieving buyer metrics from a memory to compare the buyer metrics with the buyer profile;
statistically analyzing the buyer metrics with the buyer profile; and
manipulating the environment in response to the analysis of the buyer profile wherein the environment changes to attract at least one of the senses of at least one buyer to advance the buyer seller interaction.

18. The method in a data processing system of enhancing a buyer seller interaction according to claim 17, further comprising compiling the buyer profile.

19. The method in a data processing system of enhancing a buyer seller interaction according to claim 17, further comprising rating the buyer seller interaction in response to the environment.

20. The method in a data processing system of enhancing a buyer seller interaction according to claim 17, wherein transmitting and receiving the criteria comprises processing radio frequency identification.

21. The method in a data processing system of enhancing a buyer seller interaction according to claim 17, wherein receiving the criteria comprises recording video of the at least one buyer.

22. The method in a data processing system of enhancing a buyer seller interaction according to claim 17, wherein manipulating the environment comprises activating at least one product within the environment.

23. An apparatus for enhancing a transaction between a buyer and a seller, comprising:
a transmitter operative with a criteria of the buyer;
a receiver associated with the transmitter, the receiver configured to communicate the criteria;
a processor in communication with the receiver, the processor having a compilation program which statistically analyzes the criteria to generate a buyer profile; and
a controller which manipulates an environment in response to the buyer profile wherein the environment changes to attract at least one of the senses of the buyer.

24. The apparatus for enhancing the transaction between the buyer and seller according to claim 23, wherein the transmitter is a radio frequency identification tag.

25. The apparatus for enhancing the transaction between the buyer and seller according to claim 24, wherein the radio frequency identification tag includes pre-programmed information.

26. The apparatus for enhancing the transaction between the buyer and seller according to claim 23, wherein the buyer metric includes a database of information.

27. The apparatus for enhancing the transaction between the buyer and seller according to claim 23, wherein the processor further comprises a rating program.
